(19) United States
(12) Patent Application Publication
(10) Pub. No.: US 2026/0168553 A1
(43) Pub. Date: Jun. 18, 2026

(54) HYDRO BUSHING

(71) Applicants: Hyundai Motor Company, Seoul (KR); Kia Corporation, Seoul (KR); Daeheung R&T Co., Ltd., Gimhae-si (KR)

(72) Inventors: Back-gon Ko, Hwaseong-si (KR); Min Soo Kang, Hwaseong-si (KR); Jung Youb Lee, Hwaseong-si (KR); Woocheol Jeong, Hwaseong-si (KR); Ki Young Kwon, Hwaseong-si (KR); Dongju Yoon, Hwaseong-si (KR); Wonyoung Kim, Hwaseong-si (KR); Sungwook Park, Gimhae-si (KR); Jinwook Park, Gimhae-si (KR)

(21) Appl. No.: 19/279,029

(22) Filed: Jul. 24, 2025

(30) Foreign Application Priority Data
Dec. 18, 2024 (KR) 10-2024-0189735

(51) Int. Cl. F16F 1/38; F16K 11/02

(52) U.S. Cl. CPC F16F 1/38; F16K 11/02; F16F 2230/183

(57) ABSTRACT

A hydro bushing can include a first liquid chamber configured to be filled with a fluid, a second liquid chamber configured to be filled with the fluid, and located opposite the first liquid chamber, a first fluid line configured to be opened or blocked so as to allow or prohibit movement of the fluid between the first liquid chamber and the second liquid chamber, a second fluid line configured so that the fluid can move between the first liquid chamber and the second liquid chamber based on the first fluid line being blocked, and an adjustment portion disposed on the first fluid line and configured to operate for opening or blocking the first fluid line such that the hydro bushing is configured to be amplitude-sensitive and implement a damping ratio depending on a magnitude of an input load applied to the hydro bushing.

### CROSS-REFERENCE TO RELATED APPLICATIONS

This application claims priority to and the benefit of Korean Patent Application No. 10-2024-0189735 filed with the Korean Intellectual Property Office on Dec. 18, 2024, the entire contents of which is incorporated herein by reference.

### TECHNICAL FIELD

The present disclosure relates to a hydro bushing for a vehicle.

### BACKGROUND

Noise and vibration are inevitable when driving a vehicle. However, as the technology applied to vehicles has been gradually developing and consumer demands for low vibration and low noise have increased, efforts are being made to maximize ride comfort by analyzing noise, vibration, and harshness (NVH) generated from vehicles, and NVH performance analysis is also used as a measure to estimate the degree of noise and vibration generation and reduction.

Vibration phenomena occurring in vehicles include body shaking when the engine is started and stopped, body vibration during idling, body vibration and blocking noise during high engine speeds, vibration caused by uneven surfaces, body shaking when subjected to high loads, shock caused by abrupt changes in operation such as starting or changing gears, and interference and damage caused by excessive displacement.

These vehicle vibrations, when in the low-frequency range, include torque fluctuations at low engine speeds, powertrain vibration due to inertial force and couple force due to crankshaft rotation at low engine speeds, body vibration due to unbalanced force at tire rotation, and body vibration through suspension according to road profile, and when in the high-frequency domain, include powertrain vibration due to inertial force and couple force due to crankshaft rotation at high engine speeds, gear meshing vibration in the transmission, cylinder block vibration during combustion, crankshaft bending and torsional vibration, and powertrain bending and torsional vibration.

To reduce vibrations of vehicles as described above, various types of bushings have been used in vibration-generating parts of the vehicle, such as the engine or transmission, and within the vehicle body, such as the compression arm of the suspension.

A conventional hydro bushing can be installed by being press-fitted into a compression arm and has an inertia track, which is a passage for the filled fluid to move inside. When vibration and pressure are applied to these hydro bushings, the mass of the fluid moving along the inertia track acts as a dynamic damper, maximizing the vibration isolation effect in a specific frequency band.

However, when using conventional hydro bushings, the effect could only be obtained in a specific frequency band, and there was a problem that the NVH performance is deteriorated as the dynamic spring characteristics increased rapidly in the high frequency band. This is a problem that occurs because the amount of injected fluid alone cannot satisfy all the various vehicle driving conditions, and a method to reduce the dynamic spring characteristics in the high-frequency range was required.

### SUMMARY

The present disclosure relates to a hydro bushing for a vehicle, and more particularly, the present disclosure relates to a hydro bushing provided with a liquid chamber filled with a fluid, in which a moving path of fluid between liquid chambers is set to be different depending on displacement and frequency due to the load applied to the bushing.

An embodiment of the present disclosure can provide an amplitude-sensitive hydro bushing structure capable of improving the ride comfort and improving the NVH performance, not only in the high-frequency domain but also in the low-frequency domain, by dividing the range into small amplitude and large amplitude ranges depending on the input load acting on the bushing and the magnitude of the displacement of bushing.

An amplitude-sensitive hydro bushing can be configured to implement a damping ratio depending on a magnitude of an input load, and the hydro bushing may include a first liquid chamber formed to be filled with a fluid, a second liquid chamber formed to be filled with the fluid, and located to face the first liquid chamber so that the fluid may move between the first liquid chamber and the second liquid chamber, a first fluid line formed to be opened or blocked so as to allow or prohibit movement of the fluid between the first liquid chamber and the second liquid chamber, a second fluid line formed so that the fluid may move between the first liquid chamber and the second liquid chamber when the first fluid line is blocked, and an adjustment portion disposed on the first fluid line and operating to open or block the first fluid line.

In the case of a small amplitude range in which a load smaller than a set, selected, or predetermined reference input load is applied to the bushing, the first fluid line may be opened, and the fluid may move through the first fluid line between the first liquid chamber and the second liquid chamber, and does not move through the second fluid line.

In the case of a large amplitude range in which a load greater than the set, selected, or predetermined reference input load is applied to the bushing, the first fluid line may be blocked, and the fluid may move through the second fluid line between the first liquid chamber and the second liquid chamber, and does not move through the first fluid line.

The second fluid line may include a first horizontal fluid line communicating with the first liquid chamber, and elongated from an outer circumferential portion of a lower end of the bushing in a horizontal direction, a second horizontal fluid line communicating with the second liquid chamber, and elongated from an outer circumferential portion of an upper end of the bushing in the horizontal direction, and a vertical fluid line extending in a vertical direction of the bushing, to connect the first horizontal fluid line and the second horizontal fluid line.

The adjustment portion may include a valve formed on an outer circumferential portion of the bushing, and configured to operate to be deformed and restored by a liquid pressure, and an adjustment case coupled to the valve, and configured to open or block the first fluid line according to an operation of the valve.

The valve may include a valve body integrally formed on the outer circumferential portion of the bushing to protrude toward outer side, and a plurality of stoppers formed on the valve body, to protrude in a circumference direction of the outer circumferential portion of the bushing.

The adjustment case may include a case body in which an insertion opening, into which the valve body is inserted, is formed at a center and a plurality of fluid openings through which the fluid passes are formed in an outer side of the insertion opening along the circumference direction of the outer circumferential portion of the bushing.

The plurality of stoppers and the plurality of fluid openings may be provided at locations misaligned from each other.

The stopper may be formed to protrude outward with respect to the valve body to be in contact with a side wall of the insertion opening formed in the case body, and the fluid may pass through the side wall of the insertion opening and the fluid opening.

The stopper may operate by the liquid pressure to retract inward with respect to the valve body so that an edge of the valve body becomes in contact with the side wall of the insertion opening, and the fluid does not pass through the side wall of the insertion opening and the fluid opening.

The large amplitude range may be a case where a displacement of ±0.5 mm occurs during driving vibration on a ride and handling (R&H) band moderate/moderately rough road or a case where a displacement of ±2 mm occurs during driving vibration on an impact or large-displacement rough rod.

The large amplitude range may be a driving vibration/impact excitation frequency band of about 20 Hz.

The small amplitude range may be a case where a displacement of ±0.05 mm occur in an NVH band.

The small amplitude range may be an impact booming high frequency band of 50 Hz to 600 Hz.

According to an embodiment of the present disclosure, by dividing the range into small amplitude and large amplitude ranges depending on the input load acting on the bushing and the magnitude of the displacement of bushing, the ride comfort may be improved and the NVH performance may be improved, not only in the high-frequency domain but also in the low-frequency domain.

### BRIEF DESCRIPTION OF THE DRAWINGS

FIG. 1 is a front perspective view of a hydro bushing according to an embodiment of the present disclosure.

FIG. 2 is a rear perspective view of a hydro bushing according to an embodiment of the present disclosure.

FIG. 3 is a front view of a hydro bushing according to an embodiment of the present disclosure.

FIG. 4 is a rear view of a hydro bushing according to an embodiment of the present disclosure.

FIG. 5 is a perspective exploded view showing an adjustment portion of a hydro bushing according to an embodiment of the present disclosure.

FIG. 6 is a front exploded view showing an adjustment portion of a hydro bushing according to an embodiment of the present disclosure.

FIG. 7 is a side view of a hydro bushing according to an embodiment of the present disclosure.

FIG. 8 is a perspective view showing a valve structure of an adjustment portion of a hydro bushing according to an embodiment of the present disclosure.

### DETAILED DESCRIPTION OF ILLUSTRATIVE EMBODIMENTS

Example embodiments of the present disclosure will be described more fully hereinafter with reference to the accompanying drawings. As those skilled in the art would realize, the described example embodiments may be modified in various different ways, all without departing from the spirit or scope of the present disclosure.

The drawings are schematic, and are not necessarily illustrated in accordance with a scale. Relative dimensions and ratios of portions in the drawings can be illustrated to be exaggerated or reduced in size for clarity and convenience, and the dimensions can be just examples and are not necessarily limiting. Like structures, elements, or components illustrated in two or more drawings can use same reference numerals for showing similar features. It can be understood that when an element such as a layer, film, region, or substrate is referred to as being “on” another element, it can be directly on the other element or intervening elements may also be present.

Example embodiments of the present disclosure are shown in detail, and various modifications of the drawings for other embodiments are possible. Therefore, an embodiment of the present disclosure is not necessarily limited to a specific shape of an illustrated region, but, for example, can include a change in the shape in accordance with manufacturing.

Hereinafter, a hydro bushing structure according to an embodiment of the present disclosure will be described in detail with reference to the accompanying drawings.

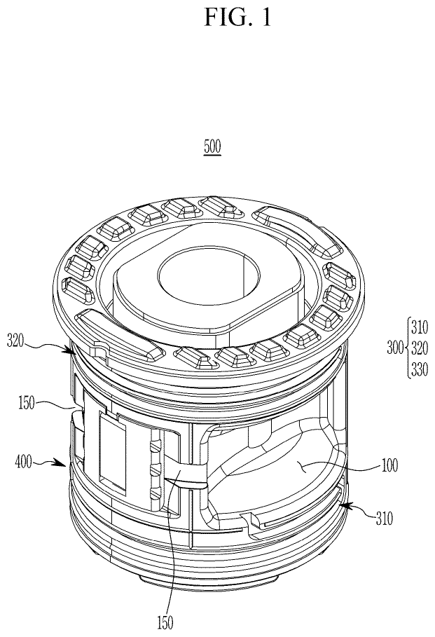

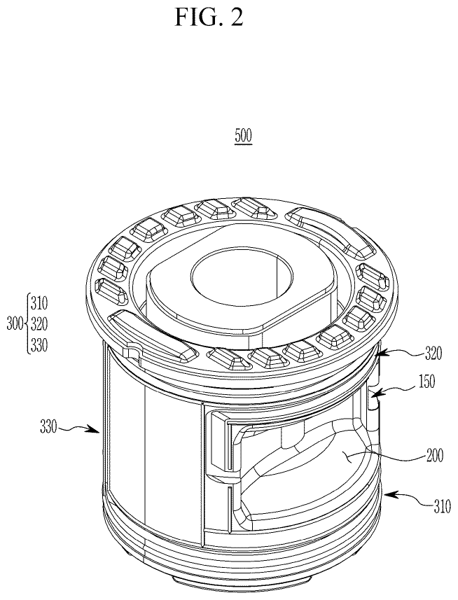

FIG. 1 is a front perspective view of a hydro bushing according to an embodiment of the present disclosure. FIG. 2 is a rear perspective view of a hydro bushing according to an embodiment of the present disclosure.

Referring to FIG. 1 and FIG. 2, a hydro bushing 500 according to an embodiment of the present disclosure may be an amplitude-sensitive hydro bushing configured to implement a damping ratio depending on a magnitude of an input load, and may include a first liquid chamber 100, a second liquid chamber 200, a first fluid line 150, a second fluid line 300, and an adjustment portion 400.

The first liquid chamber 100 and the second liquid chamber 200 may be recessed toward a body inner side of the hydro bushing 500 to form a set, selected, or predetermined space so that a fluid may be filled therein. A body of the hydro bushing 500 may be formed in an approximately cylindrical shape, and the second liquid chamber 200 may be formed at a location of the body of the hydro bushing 500, opposite the first liquid chamber 100. The fluid may move between the first liquid chamber 100 and the second liquid chamber 200.

The first liquid chamber 100 and the second liquid chamber 200 may be formed in the body of the hydro bushing 500 in the form of a chamber occupying a set, selected, or predetermined space, and a fluid can be filled therein. The pressure inside the first liquid chamber 100 and the second liquid chamber 200 may continuously change by the vibration, pressure, or the like, applied from the outside. The size of each of the liquid chambers 100 and 200 may be determined by a mechanism related to the NVH performance or the layout of the hydro bushing 500 according to an embodiment of the present disclosure, and is not particularly limited.

The first fluid line 150 formed to be opened or blocked so as to allow or prohibit movement of the fluid may be formed between the first liquid chamber 100 and the second liquid chamber 200. The first fluid line 150 may be formed to allow a flow between the fluids filled in the first liquid chamber 100 and the second liquid chamber 200. The first fluid line 150 may be formed in the body of the hydro bushing 500, over the first liquid chamber 100 and the second liquid chamber 200, at a same height.

The adjustment portion 400 may be disposed on the first fluid line 150. The adjustment portion 400 may operate to open or block the first fluid line 150 according to frequency and displacement applied to the bushing 500.

The second fluid line 300 may be formed to allow a flow between the fluids filled in the first liquid chamber 100 and the second liquid chamber 200. However, in the body of the hydro bushing 500, the second fluid line 300 may not be disposed at the same height as the first liquid chamber 100 and the second liquid chamber 200, and may be formed in upper and lower portions of the hydro bushing 500 (e.g., above and below the first liquid chamber 100 and the second liquid chamber 200) to extend along a circumference of the body of the hydro bushing 500.

The second fluid line 300 may communicate with the first liquid chamber 100, and may include a first horizontal fluid line 310 elongated from an outer circumferential portion of a lower end of the bushing 500 in a horizontal direction, a second horizontal fluid line 320 communicating with the second liquid chamber 200, and elongated from an outer circumferential portion of an upper end of the bushing 500 in the horizontal direction, and a vertical fluid line 330 extending in a vertical direction of the bushing 500 to connect the first horizontal fluid line 310 and the second horizontal fluid line 320.

The first horizontal fluid line 310 may be connected to and communicate with a lower end portion of the first liquid chamber 100, and extend from a lower portion of the bushing 500 along an entire body circumference to be connected to and communicate with a lower portion of the vertical fluid line 330. The vertical fluid line 330 may extend to an upper portion of the bushing 500, and extend from the upper portion of the bushing 500 along an entire body circumference of the bushing 500 to be connected to and communicate with a central side portion of the second liquid chamber 200.

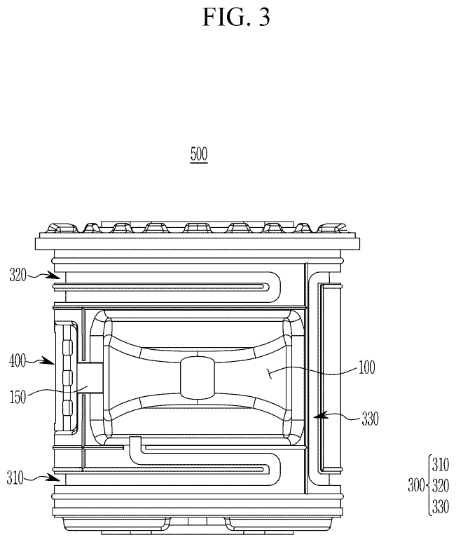

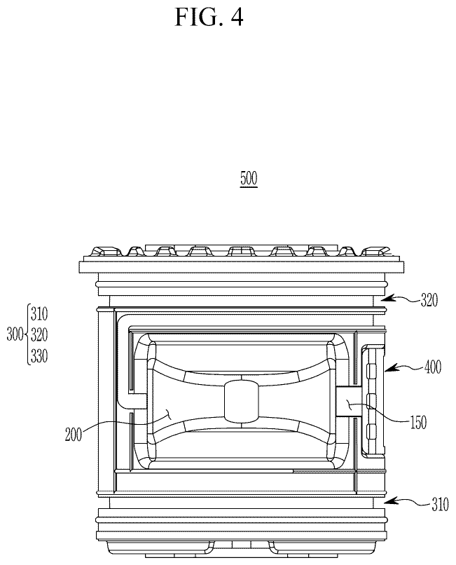

FIG. 3 is a front view of the hydro bushing according to an embodiment of the present disclosure. FIG. 4 is a rear view of the hydro bushing according to an embodiment of the present disclosure.

As shown in FIG. 3 and FIG. 4, the adjustment portion 400 may be disposed in a central portion of the first fluid line 150 between the first liquid chamber 100 and the second liquid chamber 200, to open or block the first fluid line 150, so as to allow or prohibit movement of the fluid. The adjustment portion 400 may be disposed on a left side of the first liquid chamber 100 and a right side of the second liquid chamber 200.

When the first fluid line 150 is opened by the adjustment portion 400, the fluid may not move through the second fluid line 300 (or fluid movement in the second fluid line 300 may be more restricted than fluid movement through the first fluid line 150, and thus the fluid may have negligible or much less movement through the second fluid line 300 because the first fluid line 150 can be a much less resistive path for the fluid than the second fluid line 300 when the first fluid line 150 is opened or unblocked at the adjustment portion 400). When the first fluid line 150 is closed (or blocked) by the adjustment portion 400, the fluid may move through the second fluid line 300 because the second fluid line 300 becomes a much less resistive path for the fluid compared to the first fluid line 150 being blocked.

As shown in FIG. 3, the first horizontal fluid line 310 of the second fluid line 300 may communicate at the lower end portion of the first liquid chamber 100 to extend toward an opposite side of the adjustment portion 400, and may be bent toward the adjustment portion 400 to extend therefrom. The first horizontal fluid line 310 may extend to pass through the adjustment portion 400 and a lower end portion of the second liquid chamber 200, and may communicate with the lower portion of the vertical fluid line 330. The vertical fluid line 330 may extend toward the upper portion of the bushing 500, and an upper portion of the vertical fluid line 330 may be connected to the second horizontal fluid line 320.

As shown in FIG. 4, the second horizontal fluid line 320 may extend from an upper end portion of the bushing 500 to pass through the second liquid chamber 200, the adjustment portion 400, and an upper end portion of the first liquid chamber 100, and may be bent toward the adjustment portion 400 to extend therefrom. The second horizontal fluid line 320 may extend to pass through the first liquid chamber 100, the adjustment portion 400, and an upper end portion of the second liquid chamber 200, and then be connected to and communicate with the central side portion of the second liquid chamber 200.

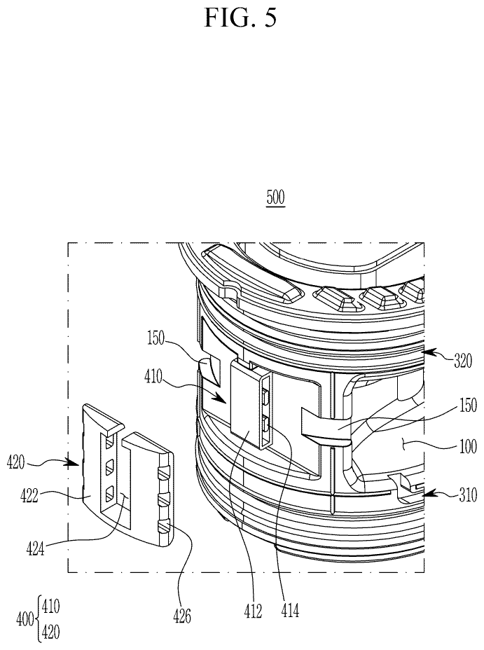

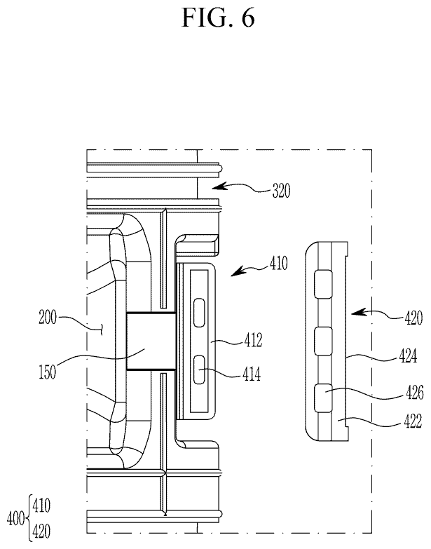

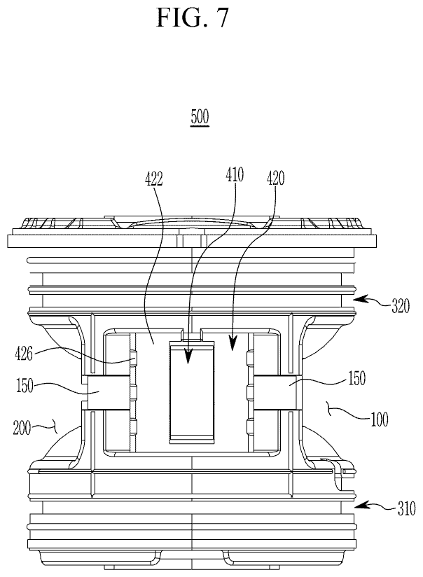

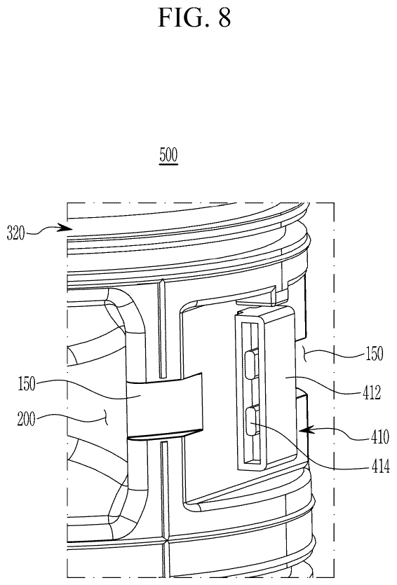

FIG. 5 is a perspective view showing the adjustment portion of the hydro bushing according to an embodiment of the present disclosure. FIG. 6 is a front view showing the adjustment portion of the hydro bushing according to an embodiment of the present disclosure. FIG. 7 is a side view of the hydro bushing according to an embodiment of the present disclosure. FIG. 8 is a perspective view showing valve structure of the adjustment portion of the hydro bushing according to an embodiment of the present disclosure.

As shown in FIG. 5 to FIG. 8, the adjustment portion 400 may be disposed on the first fluid line 150, and may include a valve 410 and an adjustment case 420 coupled to the valve 410.

The valve 410 may be integrally formed with the bushing 500 on an outer circumferential portion of the bushing 500, and may operate to be deformed and restored by a liquid pressured. The valve 410 may be made of an elastic member or rubber.

The adjustment case 420 may be coupled to cover a side portion of the valve 410, and may open or block the first fluid line 150 according to an operation of the valve 410.

The valve 410 may be formed to protrude toward an outer side of the bushing 500, and may include a valve body 412 having an approximately rectangular hexahedral shape, and a stopper 414 formed on the valve body 412, to protrude in a circumference direction of the outer circumferential portion of the bushing 500. The stopper 414 may be provided on both side portions of the valve body 412, in a plural quantity in the vertical direction to be parallel to each other.

In the adjustment case 420, an insertion opening 424 into which the valve body 412 can be inserted may be formed at a center, and the fluid opening 426 through which the fluid can pass may be formed in an outer side of the insertion opening 424 along the circumference direction of the outer circumferential portion of the bushing 500. The fluid opening 426 may be provided on both outer surfaces of the insertion opening 424, in a plural quantity in the vertical direction to be parallel to each other.

A plurality of stoppers 414 and a plurality of fluid openings 426 may be provided at locations misaligned from each other, and an interval may be formed between the both outer surfaces of the insertion opening 424 of the adjustment case 420 and the surfaces of the valve body 412 between the stoppers 414 so that the fluid can pass therethrough.

The stopper 414 and the valve body 412 may be made of an elastic member or rubber, and may be rapidly deformed and restored according to the displacement and frequency according to the input load applied to the bushing 500.

In the case of a small amplitude range in which a load smaller than a set, selected, or predetermined reference input load is applied to the bushing 500, the first fluid line 150 may be opened, and the fluid may move through the first fluid line 150 between the first liquid chamber 100 and the second liquid chamber 200, and does not move (or has only negligible movement) through the second fluid line 300.

The small amplitude range may be a case where displacements of approximately ±0.05 mm occur in the NVH band. The small amplitude range may be an impact booming high frequency band of about 50 Hz to about 600 Hz.

In the small amplitude range, the stopper 414 of the valve 410 may be formed to protrude outward with respect to the valve body 412, and may be in contact with a side wall of the insertion opening 424 formed in a case body 422. Because the fluid may pass through the side wall of the insertion opening 424 and the fluid opening 426, the fluid may move from the first liquid chamber 100 to the second liquid chamber 200 through the first fluid line 150.

In the case of a large amplitude range in which a load greater than the set, selected, or predetermined reference input load is applied to the bushing 500, the first fluid line 150 may be blocked, and the fluid may move through the second fluid line 300 between the first liquid chamber 100 and the second liquid chamber 200, and does not move (or has only negligible movement) through the first fluid line 150.

The large amplitude region can be the case where displacement of approximately ±0.5 mm occurs during driving vibration on a moderate/moderately rough road, or the case where displacement of approximately ±2 mm occurs during driving vibration on an impact or large-magnitude rough road. The large amplitude range may be a driving vibration/impact excitation frequency band of about 20 Hz.

In the large amplitude range, the stopper 414 may operate by the liquid pressure to retract inward with respect to the valve body 412 so that an edge of the valve body 412 becomes in contact with the side wall of the insertion opening 424, and the fluid does not pass through the side wall of the insertion opening 424 and the fluid opening 426. That is, because the adjustment portion 400 blocks the first fluid line 150, the fluid may move from the first liquid chamber 100 to the second liquid chamber 200 through the second fluid line 300.

As such, according to an embodiment of the present disclosure, by dividing the range into small amplitude and the large amplitude ranges depending on the input load acting on the bushing and the magnitude of the displacement of bushing, the ride comfort may be improved and the NVH performance may be improved, not only in the high-frequency domain but also in the low-frequency domain.

While this disclosure has been described in connection with what is presently considered to be practical example embodiments of the present disclosure, it can be understood that the disclosure is not necessarily limited to the disclosed example embodiments. On the contrary, the present disclosure is intended to cover various modifications and equivalent arrangements included within the spirit and scopes of appended claims.

What is claimed is:

1. A hydro bushing comprising:
a first liquid chamber configured to be filled with a fluid;
a second liquid chamber configured to be filled with the fluid, and located opposite the first liquid chamber, and configured such that the fluid can move between the first liquid chamber and the second liquid chamber;
a first fluid line configured to be opened or blocked so as to allow or prohibit movement of the fluid between the first liquid chamber and the second liquid chamber;
a second fluid line configured so that the fluid can move between the first liquid chamber and the second liquid chamber based on the first fluid line being blocked; and
an adjustment portion located at the first fluid line and configured for opening or blocking the first fluid line,
wherein the hydro bushing is configured to be sensitive based on a magnitude of an input load applicable to the hydro bushing.

2. The hydro bushing of claim 1, wherein the hydro bushing is configured to based on a first amplitude range of the input load being smaller than a reference input load, open the first fluid line such that the fluid moves more through the first fluid line than through the second fluid line.

3. The hydro bushing of claim 2, wherein the hydro bushing is configured to, based on a second amplitude range of the input load being greater than the reference input load, block the first fluid line such that the fluid moves more through than through the first fluid line.

4. The hydro bushing of claim 1, wherein the second fluid line comprises:
a first horizontal fluid line communicating with the first liquid chamber and elongated from a first outer circumferential portion of a lower end of the hydro bushing in a horizontal direction;
a second horizontal fluid line communicating with the second liquid chamber and elongated from a second outer circumferential portion of an upper end of the hydro bushing in the horizontal direction; and
a vertical fluid line extending in a vertical direction of the hydro bushing to connect the first horizontal fluid line and the second horizontal fluid line.

5. The hydro bushing of claim 1, wherein the adjustment portion comprises:
a valve on an outer circumferential portion of the hydro bushing, and configured to operate to be deformed and restored by a liquid pressure; and
an adjustment case coupled to the valve, and configured to open or block the first fluid line according to an operation of the valve.

6. The hydro bushing of claim 5, wherein the valve comprises:
a valve body integrally on the outer circumferential portion of the hydro bushing to protrude outward; and
a plurality of stoppers protruding in a circumference direction from the valve body.

7. The hydro bushing of claim 6, wherein the adjustment case comprises a case body having an insertion opening at a center into which the valve body is inserted, and wherein the case body includes a plurality of fluid holes extending from outer sides of the case body along the circumference direction and opening to the insertion opening.

8. The hydro bushing of claim 7, wherein the plurality of stoppers and the plurality of fluid holes are at locations misaligned from each other.

9. The hydro bushing of claim 8, wherein at least one stopper of the plurality of stoppers protrudes outward with respect to the valve body to be in contact with a side wall of the insertion opening of the case body such that the fluid can pass through the side wall at the insertion opening and the plurality of fluid holes.

10. The hydro bushing of claim 9, wherein the at least one stopper of the plurality of stoppers is configured to operate by the liquid pressure to retract inward with respect to the valve body so that
an edge of the valve body contacts the side wall of the insertion opening and so that
the fluid is blocked for passing through the side wall of the insertion opening and the plurality of fluid holes.

11. The hydro bushing of claim 3, wherein the first amplitude range is based on a first displacement of ±0.5 mm occurring during a road-surface driving vibration or based on a second displacement of ±2 mm occurring during an impact driving vibration.

12. The hydro bushing of claim 11, wherein the first amplitude range is based on a frequency band of about 20 Hz.

13. The hydro bushing of claim 3, wherein the second amplitude range is based on a displacement of ±0.05 mm.

14. The hydro bushing of claim 13, wherein the second amplitude range is based on a frequency band of 50 Hz to 600 Hz.

15. A bushing comprising:
a bushing body;
a first liquid chamber extending into a first side of the bushing body and configured to be filled with a fluid;
a second liquid chamber extending into a second side of the bushing body and configured to be filled with the fluid, wherein the first side is opposite the second side;
a first fluid line extending between the first liquid chamber and the second liquid chamber;
a second fluid line extending between the first liquid chamber and the second liquid chamber; and
a passive valve mechanism in the first fluid line, wherein the passive valve mechanism is configured to open or block the first fluid line based on an amplitude of vibration applied to the bushing, such that the fluid can flow between the first liquid chamber and the second liquid chamber via the first fluid line more than via the second fluid line to provide a first vibration dampening rate with the bushing based on the first fluid line being open by the passive valve mechanism, and such that the fluid can flow between the first liquid chamber and the second liquid chamber via the second fluid line more than the first fluid line to provide a second vibration dampening rate with the bushing based on the first fluid line being blocked by the passive valve mechanism, wherein the first vibration dampening rate is different than the second vibration dampening rate.

16. The bushing of claim 15, wherein the passive valve mechanism comprises:
a valve on an outer circumferential portion of the bushing, wherein the valve configured to be deformed and restored by a liquid pressure of the fluid, and wherein the valve comprises:
a valve body integrally on the outer circumferential portion of the bushing to protrude outward, and
stoppers protruding in a circumference direction from the valve body; and
an adjustment case coupled to the valve, and configured to open or block the first fluid line based on the deformation and restoration of the valve by the liquid pressure of the fluid, wherein the adjustment case comprises a case body having an insertion opening at a center into which the valve body is inserted, and wherein the case body includes fluid holes extending from outer sides of the case body along the circumference direction and opening to the insertion opening.

17. The bushing of claim 16, wherein in a restored state of the valve the stoppers and the fluid holes are at locations misaligned from each other.

18. A bushing comprising:
a bushing body;
a first liquid chamber extending into a first side of the bushing body and configured to be filled with a fluid;
a second liquid chamber extending into a second side of the bushing body and configured to be filled with the fluid, wherein the first side is opposite the second side;
a first fluid line extending between the first liquid chamber and the second liquid chamber;
a second fluid line extending between the first liquid chamber and the second liquid chamber, wherein the second fluid line comprises:
a first horizontal fluid line communicating with the first liquid chamber, and elongated from a first outer circumferential portion of a lower end of the bushing in a horizontal direction,
a second horizontal fluid line communicating with the second liquid chamber, and elongated from a second outer circumferential portion of an upper end of the bushing in the horizontal direction, and
a vertical fluid line extending in a vertical direction of the bushing, to connect the first horizontal fluid line and the second horizontal fluid line; and
a passive valve mechanism in the first fluid line, wherein the passive valve mechanism is configured to open or block the first fluid line based on an amplitude of vibration applied to the bushing, such that the fluid can flow between the first liquid chamber and the second liquid chamber via the first fluid line more than via the second fluid line to provide a first vibration dampening rate with the bushing based on the first fluid line being open by the passive valve mechanism, and such that the fluid can flow between the first liquid chamber and the second liquid chamber via the second fluid line more than the first fluid line to provide a second vibration dampening rate with the bushing based on the first fluid line being blocked by the passive valve mechanism, wherein the first vibration dampening rate is different than the second vibration dampening rate.

19. The bushing of claim 18, wherein the passive valve mechanism comprises:
a valve on an outer circumferential portion of the bushing, wherein the valve configured to be deformed and restored by a liquid pressure of the fluid, and wherein the valve comprises:
a valve body integrally on the outer circumferential portion of the bushing to protrude outward, and
stoppers protruding in a circumference direction from the valve body; and
an adjustment case coupled to the valve, and configured to open or block the first fluid line based on the deformation and restoration of the valve by the liquid pressure of the fluid, wherein the adjustment case comprises a case body having an insertion opening at a center into which the valve body is inserted, and wherein the case body includes fluid holes extending from outer sides of the case body along the circumference direction and opening to the insertion opening.

20. The bushing of claim 19, wherein in a restored state of the valve the stoppers and the fluid holes are at locations misaligned from each other.
